(19) United States
(12) Patent Application Publication
(10) Pub. No.: US 2026/0055966 A1
(43) Pub. Date: Feb. 26, 2026

(54) HEAT EXCHANGER AND METHOD OF MANUFACTURE THEREFOR

(71) Applicant: Conflux Technology Pty Ltd, Grovedale, Victoria (AU)

(72) Inventors: Paul HENDY, Grovedale, Victoria (AU); Michael FULLER, Grovedale, Victoria (AU); Glenn REES, Grovedale, Victoria (AU); Jason VELARDO, Grovedale, Victoria (AU)

(21) Appl. No.: 19/103,487

(22) PCT Filed: Aug. 11, 2023
(86) PCT No.: PCT/AU2023/050759

§ 371 Date: Feb. 12, 2025

(30) Foreign Application Priority Data
Aug. 12, 2022 (AU) 2022902293

(51) Int. Cl. F28D 7/10

(52) U.S. Cl. CPC F28D 7/10

(57) ABSTRACT

A crossflow heat exchanger constructed by an additive manufacturing process defining a build direction, the heat exchanger having a core with fluid tubes extending in a first direction therethrough for carrying a first working fluid, the heat exchanger core having a plurality of heat exchange fins extending from the fluid tubes, the fins being substantially planar, parallel to one another and transverse to the first direction, wherein spaces between the fins allow for a second working fluid to flow therebetween, in use, in a second direction orthogonal to the first direction.

### TECHNICAL FIELD

This invention relates to heat exchangers. In particular, a crossflow heat exchanger is disclosed herein.

### BACKGROUND

The purpose of a heat exchanger is to transfer heat between two or more separate streams of working fluids. Depending on the relative direction of flow of the respective working fluids, heat exchangers can be broadly classified into several forms. In crossflow heat exchangers, the working fluids flow in directions perpendicular to one another. This is to be contrasted with counterflow heat exchangers, where the working fluids flow parallel to one another, in opposing directions. The perpendicular flow directions in a crossflow heat exchanger allows for simplicity in ducting and manifold design for directing fluid into the heat exchanger core.

For a given application, a heat exchanger may be required to have a certain capacity for heat exchange (or rate of exchange) to meet the requirements of the application. Beyond that, there are a number of other performance and design factors that may be optimized or taken into consideration when constructing a heat exchanger. For example, some high performance applications require the heat exchanger to be made as compact as possible.

Using traditional manufacturing techniques to create a crossflow heat exchanger can be a laborious process, involving multiple stages of joining and brazing of fins, tubes, endplates, and manifolds together to form a final assembly. Traditional techniques also involve the risk of mechanical integrity issues being introduced at joining/brazing regions, and there are constraints on the core geometry that can be produced. Moreover, the thermal performance of a heat exchanger is derived from its core geometry-the shape and dimensions of fins and tubes within the heat exchanger core have significant influence on its ability to transfer heat. To optimize toward minimum size, a heat exchanger core should have high surface area density. As the heat exchanger core features get smaller and more closely packed, it becomes more difficult to reliably produce using traditional manufacturing techniques.

Additive manufacturing technology can be used to create more sophisticated geometry in a heat exchanger core than is able to be realized by use of traditionally manufacturing methods. Through careful design, additive manufacturing provides a means to make a heat exchanger core with high compactness, since additive manufacturing is able to produce high resolution geometry. Nevertheless, additive manufacturing has its own considerations, including constraints and limitations, to be taken into account when designing and producing the heat exchanger core.

### SUMMARY

According to one aspect of the present invention there is provided a crossflow heat exchanger constructed by an additive manufacturing process defining a build direction, the heat exchanger having a core with fluid tubes extending in a first direction therethrough for carrying a first working fluid, the heat exchanger core having a plurality of heat exchange fins extending from the fluid tubes, the fins being substantially planar, parallel to one another and transverse to the first direction, wherein spaces between the fins allow for a second working fluid to flow therebetween, in use, in a second direction orthogonal to the first direction

Embodiments of the invention preferably have substantially all of the surfaces in the heat exchanger core with an angle relative to the build direction axis that allows the heat exchanger to be built upright (vertical orientation).

In some embodiments of the heat exchanger core substantially all of the surfaces have a relatively small angle with respect to the build direction axis, for example less than a predetermined angle.

In embodiments of the invention, the fluid tubes have a cross section with a relatively elongate dimension parallel to the second direction. The fluid tubes may include turbulence-inducing interior structure designed to prevent or reduce laminar flow of the first working fluid for better heat transfer.

In embodiments of the invention, the fluid tubes are arranged in a plurality of rows, with the positions of the fluid tubes in adjacent rows being staggered. The fins may extend between fluid tubes within rows, and each row of fluid tubes may have more than one row of fins. Adjacent rows of fins are preferably staggered with respect to one another in the first direction. Micro-fins may be provided to extend between adjacent rows of fins, the micro-fins being oriented with a planar dimension transverse to the fins. The fins may be formed with a pattern or mesh of apertures therethrough, to increase surface area, reduce material and promote mixing of the second working fluid.

### DRAWINGS

The invention may be better understood from the following description of embodiments thereof, provided by way of example only and with reference to the accompanying drawings, in which:

FIG. 1 is a perspective view of a heat exchanger according to an embodiment of the invention;

FIG. 2 shows the heat exchanger in orthogonal views;

FIG. 3 is a side view of the heat exchanger;

FIG. 4 shows a section A-A from FIG. 3;

FIG. 5 shows an enlarged region B from FIG. 4;

FIG. 6 is an enlarged view of the fin structure in the heat exchanger core;

FIG. 7 is an end view of the heat exchanger;

FIG. 8 shows a section C-C from FIG. 7;

FIG. 9 shows an enlarged region D from FIG. 8;

FIG. 10 is an end view of the heat exchanger;

FIG. 11 shows a section E-E from FIG. 10;

FIG. 12 shows an enlarged region F from FIG. 11;

FIGS. 13 and 14 are perspective views of a portion of the heat exchanger core showing the arrangement of fins and conduits therein;

FIG. 15 shows internal structure from a conduit of the heat exchanger;

FIG. 16 diagrammatically illustrates the inclusion of support structures for certain features in an additively manufactured item;

FIG. 17 is a plan view showing a region J from FIG. 13;

FIG. 18 shows a section G-G as indicated in FIG. 17;

FIG. 19 shows a section H-H as indicated in FIG. 17;

FIG. 20 shows a section K-K as indicated in FIG. 17.

### DETAILED DESCRIPTION

A crossflow heat exchanger according to an embodiment of the invention is described herein. The detailed description uses numerical and letter designations to refer to features in the drawings. Like or similar designations in the drawings and description have been used to refer to like or similar parts of the heat exchanger.

The terms “first”, “second”, and “third” may be used interchangeably herein to distinguish one component from another without intending to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, a “fluid” may be a gas or a liquid. Indeed, for a heat exchanger designed to operate with first and second working fluids, in operation the two fluids may be in different states, e.g. one a gas and the other a liquid. For instance, in one application the cooling fluid is air (gaseous state), and the cooled fluid is water (liquid state). Nevertheless, the principles underlying the present invention may be used to create heat exchangers that are adapted for other types of liquid and gaseous fluids, where the cooled fluid and the cooling fluid are the same fluids or different fluids. Other examples of the cooled fluid and the cooling fluid include oil, fuel, hydraulic fluid, combustion gas, refrigerant, refrigerant mixtures, dielectric fluid for cooling avionics or other aircraft electronic systems, water, water-based compounds, water mixed with antifreeze additives (e.g., alcohol or glycol compounds), and any other organic or inorganic heat transfer fluid or fluid blends capable of persistent heat transport at elevated or reduced temperature.

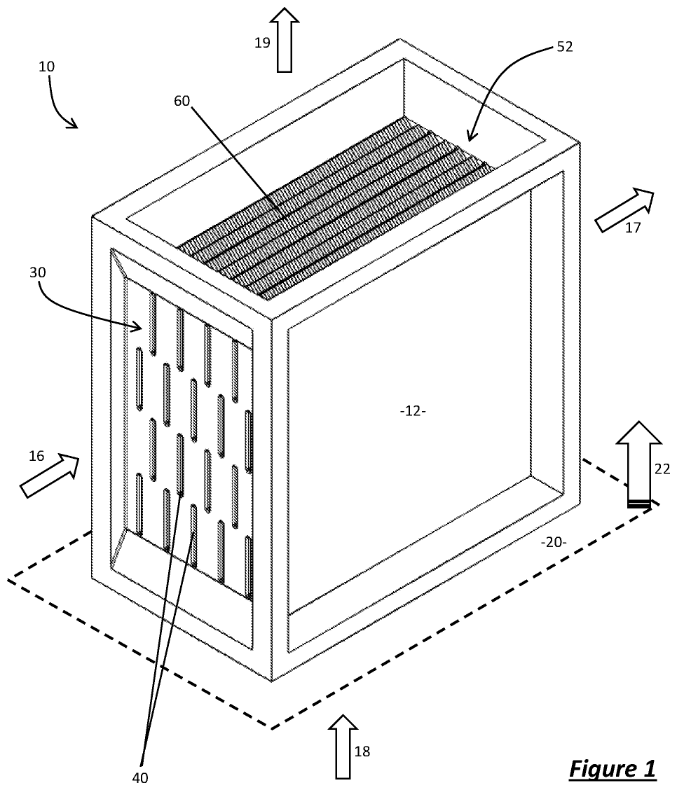

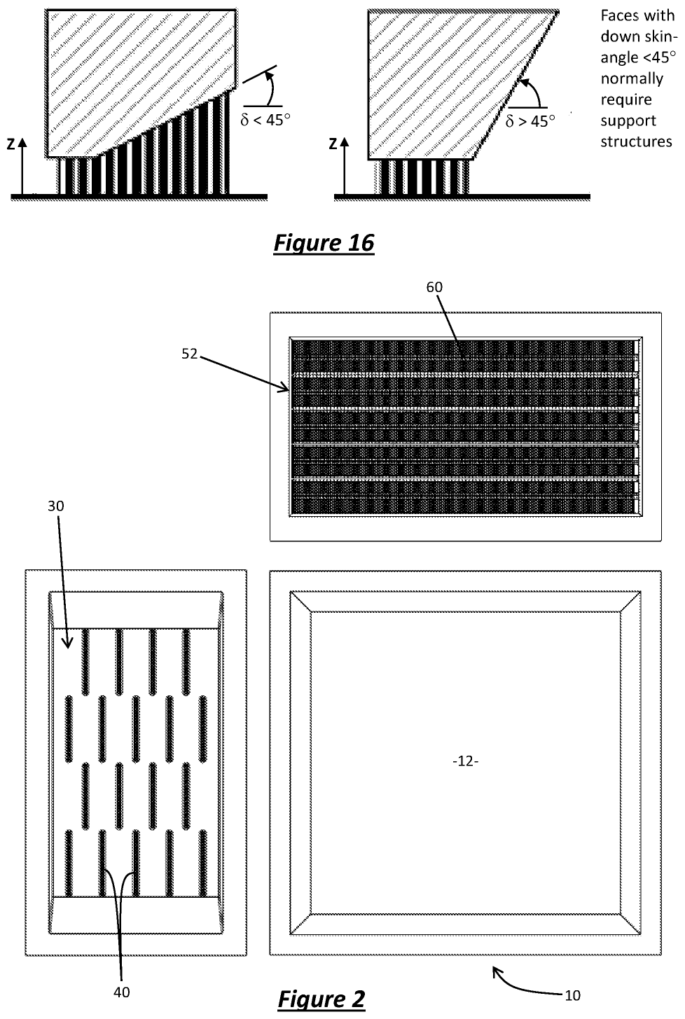

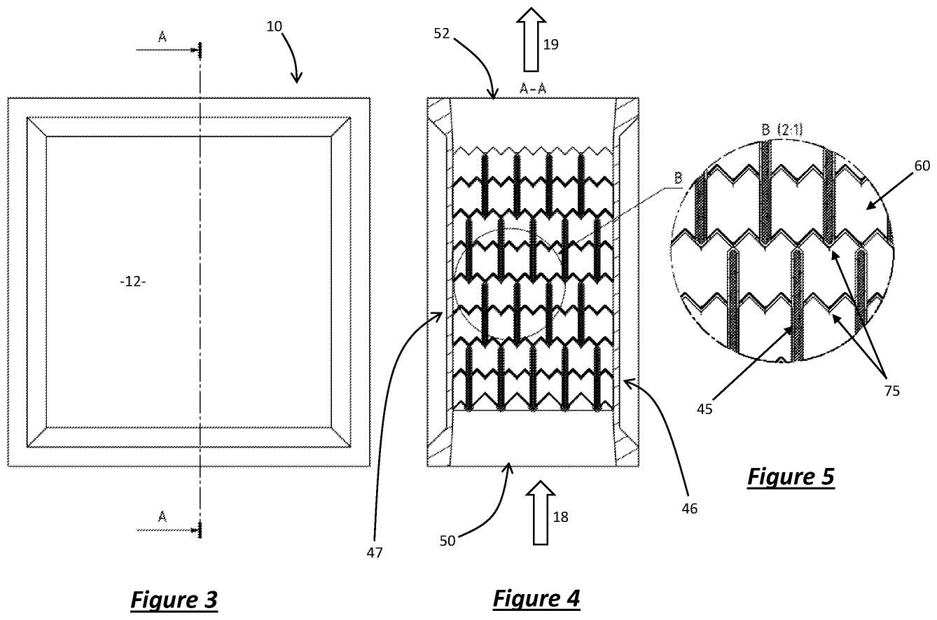

A heat exchanger 10 (FIG. 1) and a method for manufacturing the heat exchanger are disclosed. The heat exchanger core includes a plurality of fluid conduits and an array of heat transfer fins that are designed for creation using additive manufacturing methods although, in general, the disclosed heat exchanger 10 may be manufactured or formed using any suitable process. Nevertheless, in accordance with certain aspects of the present subject matter, the heat exchanger 10 may be formed using an additive-manufacturing process, such as a 3-D printing process. The use of such a process may allow heat exchanger 10 to be formed integrally, as a single monolithic component, as described herein according to an exemplary embodiment. In particular, the manufacturing process may allow heat exchanger 10 to be integrally formed and include a variety of features not possible when using prior manufacturing methods.

As used herein, the terms “additively manufactured” or “additive manufacturing techniques or processes” refer generally to manufacturing processes wherein successive layers of material(s) are provided on each other to “build-up”, layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter.

An exemplary additive manufacturing process will now be described. Additive manufacturing processes fabricate components using three-dimensional (3D) information, for example a three-dimensional computer model, of the component. Accordingly, a three-dimensional design model of heat exchanger 10 may be defined prior to manufacturing. In this regard, a model of heat exchanger 10 may be constructed using a suitable computer aided design (CAD) program to define the three-dimensional design model of heat exchanger 10. As another example, a model or prototype of heat exchanger may be scanned to determine the three-dimensional information of heat exchanger 10.

The design model may include data such as 3D numeric coordinates of the entire configuration of the component including both external and internal surfaces of heat exchanger 10. For example, the design model may define the external housing, the heat exchanging structure, internal fluid channels or circulation conduits, fins, openings, support structures, etc. Depending on the additive manufacturing process to be employed, the three-dimensional design model may be converted into a plurality of slices or segments, e.g., along a central (e.g., vertical) axis of the component or any other suitable axis. Each slice may define a two-dimensional (2D) cross section of the component for a predetermined height of the slice. The plurality of successive 2D cross-sectional slices together form the 3D component. The component is then “built-up” slice-by-slice, or layer-by-layer, until finished.

In this manner, heat exchanger 10 is fabricated using the additive process, or more specifically each layer is successively formed, e.g., by melting metal powder using laser energy or heat or by fusing or polymerizing a plastic. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

According to current additive manufacturing capabilities, each successive layer may be, for example, between about 10 μm and 200 μm, although the thickness may be selected or determined based on any number of parameters and may be any suitable size according to alternative embodiments. Therefore, utilizing the additive formation methods described above, one might consider the minimum feature size, in the ‘build direction’ to be as small as one thickness of the associated powder layer utilized during the additive formation process. In the dimensions transverse to the build direction, the minimum feature size is determined, at least in part, by the spot size of the laser beam. According to current additive manufacturing capability limits, a laser beam spot size in the range of about 40 μm to 80 μm may be expected. The minimum size of an arbitrary three-dimensional feature that can be formed using additive manufacturing may therefore depend on both the layer thickness and the laser spot size, in the general case.

As previously noted, to optimize a heat exchanger toward minimum size, the heat exchanger core should have high surface area density. This usually means the heat exchanger core features get smaller and more closely packed together. The constraints on minimum manufacturable feature size that are imposed by virtue of the process parameters discussed above are therefore relevant in the heat exchanger design, to inform the designer how small and close together the core features can be, within the limits of manufacturability.

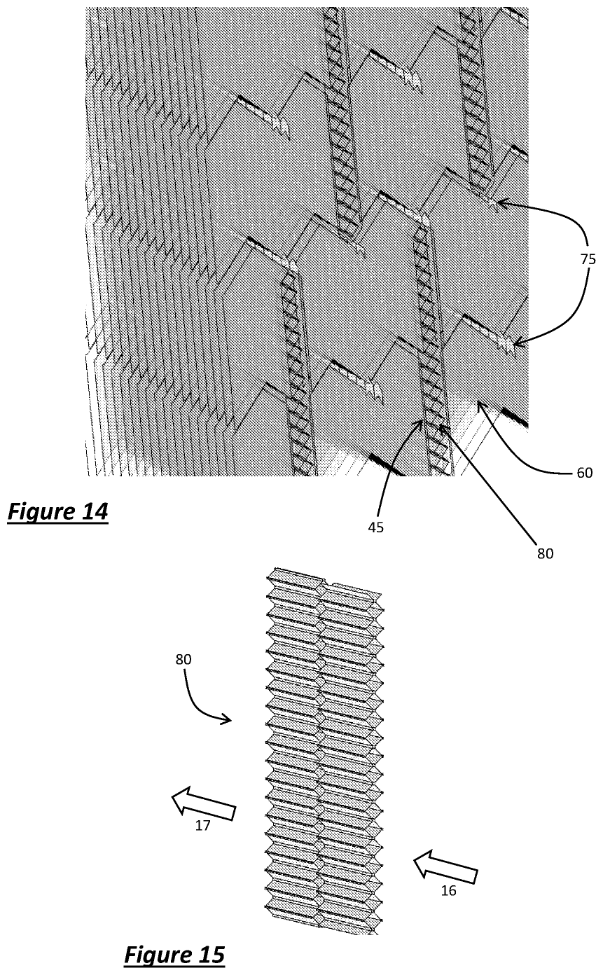

In addition to the primary process-related feature size constraints of layer thickness and energy beam spot size, there are other factors that can affect the final form of an additively manufactured heat exchanger having fine features and tolerances. According to the build direction of the additively manufactured item, surfaces at some angles will turn out smoother than surfaces at other angles. In other words, the build direction employed to additively manufacture a particular item can impact on how faithfully certain features in the manufactured item in fact resemble the computer model design from which it is made. Moreover, not all features that can be designed in a computer model can necessarily be manufactured unless provisions are made for the process limitations. An example of this is illustrated in FIG. 16 which shows how certain features and faces may require support structures (the arrow labelled Z indicates the additive manufacturing build direction). In general, design for additive manufacturing rules (dfAM) provide that support structures should be included to support overhanging features where the angle of the surface relative to the build platform is less than about 45 degrees (the build platform is orthogonal to the build direction), although certain additive manufacturing machines, processes and/or materials can build surfaces ‘flatter’ than 45 degrees, albeit with down skin roughness. Any support structures must be removed (e.g. manually) after the additive manufacturing process is complete. For external faces on the product this is possible, however it may not be feasible to remove support structures if they were to be included in the internal structure of the product which are inaccessible.

Embodiments of the present invention as disclosed herein are designed with these process limitations in mind. Printing the heat exchanger core geometry in a vertical (upright) orientation provides the most compact core and dimensionally accurate fin geometry, as vertical orientation print reduces downward facing surfaces allowing lowest minimum feature distance to be achieved. However there are also other challenges associated with producing a crossflow heat exchanger core in vertical build orientation, which are addressed by the heat exchanger design as disclosed herein. To this end, as will be appreciated from the following description, substantially all of the surfaces of the heat exchanger core according to embodiments of the present invention have angles with respect to the build direction axis that allows the heat exchanger to be built in vertical orientation. Therefore requiring no extraneous support structures.

As shown in the drawings, a heat exchanger 10 according to an exemplary embodiment of the invention has an external shape generally in the form of a rectangular prism with three pairs of opposed faces. The two side faces are closed by way of side plates 12. The heat exchanger 10 operates in a cross-flow configuration, wherein first and second working fluids pass through the heat exchanger core in cross-ways orthogonal directions. The first working fluid may be a liquid coolant, for example, which enters the heat exchanger 10 in the direction indicated by arrow 16 through entry apertures 40 formed in one end face 30. Corresponding exit apertures are provided in the opposite end face 32 through which the coolant exits the heat exchanger in the direction indicated by arrow 17. The corresponding coolant entry and exit apertures are interconnected to one another by way of conduits which extend through the heat exchanger core to convey the coolant fluid.

The top and bottom faces 52, 50 of the heat exchanger 10 are open to permit the second working fluid (e.g. air) to flow into and out of the heat exchanger core in the directions indicated by arrows 18, 19. The directions of bulk fluid flow of the first and second working fluids within the heat exchanger core are substantially orthogonal to one another.

The conduits 45 that convey the first working fluid through the heat exchanger core are thin-walled features that are elongate in the dimension parallel to the second working fluid flow direction and narrow in the other cross-dimension (FIG. 4). They are arranged in a plurality of rows (e.g. 46, 47), each row extending from side to side and having a plurality of conduits 45. The positions of the conduits 45 in adjacent rows are offset from each other in a staggered arrangement.

An array of fins 60 is provided in the core of the heat exchanger 10 extending across the width of the core from one side wall 12 to the other, interconnecting the conduits 45. The fins 60 are parallel to one another with gaps in between to allow the second working fluid to flow. The fins 60 are also arranged in a series of rows (e.g. 61, 62) extending from side to side across the core of the heat exchanger 10. In the illustrated embodiment there are two rows of fins for each row of conduits. The fins in adjacent rows are offset from one another in a staggered arrangement, wherein the fins in one row align with the gaps between the fins in the next row.

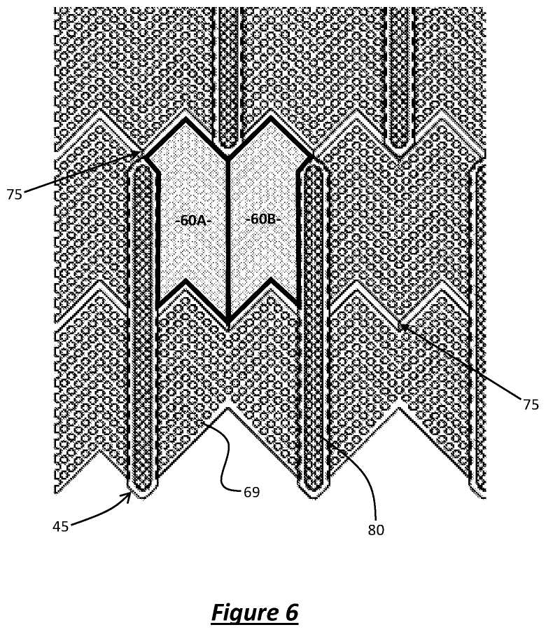

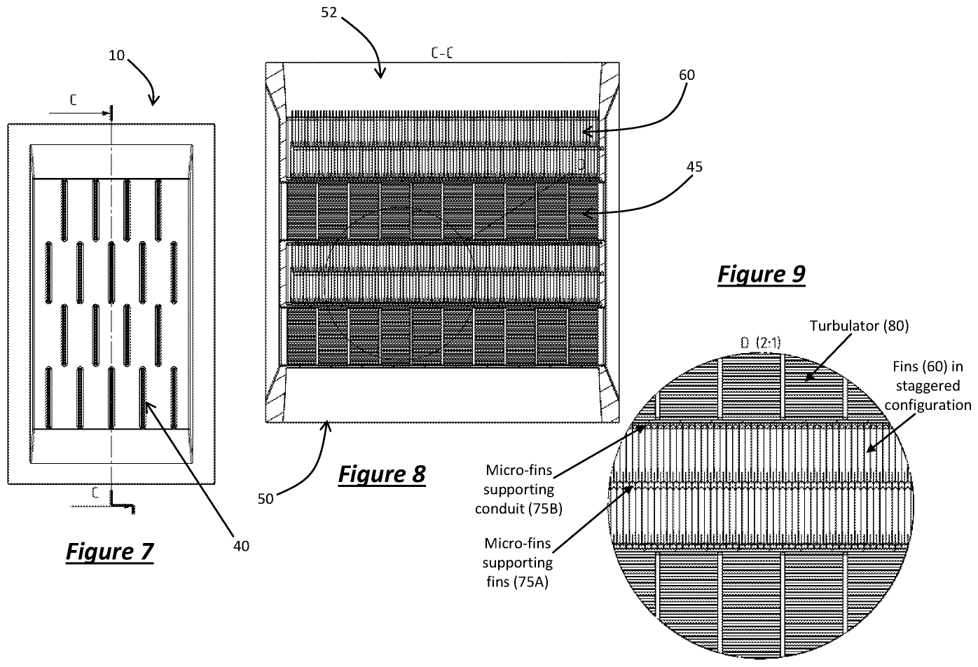

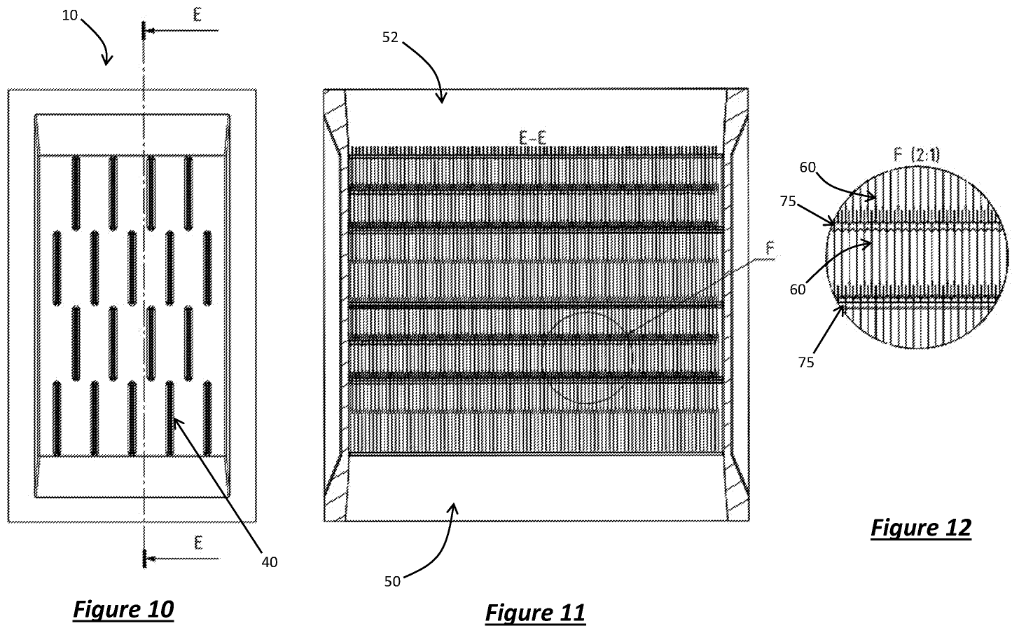

An enlarged view of the fins 60 and conduits 45 is shown in FIG. 6 in which the detailed structure can be seen. Pairs of fins 60 extend between adjacent conduits 45, or between a conduit 45 and the side wall of the heat exchanger for those fins on the edges of the heat exchanger core. Two individual fins 60A and 60B are highlighted, from which it can be seen that each fin 60 is formed in a chevron shape, having a central peak at the top edge and a complementary angled indentation on the bottom edge. The top and bottom edges of the fins 60 thus form a saw-tooth pattern across the width of the heat exchanger core, and these edges are unsupported apart from the inclusion of transverse interstitial micro-fins 75, which span adjacent fins 60 in the core array to provide additional structure and support between the fins and conduits. The supporting micro-fins 75 are located where pairs of fins 60 meet each other, but the micro-fins are orientated orthogonal to the orientation of the fins 60. The micro-fins 75 also have a substantially chevron shaped structure.

The arrangement and structure of the array of fins 60 and conduits 45 is designed to promote mixing of fluid streams that pass through the heat exchanger core for the purpose of increasing heat transfer. As the second working fluid passes through the heat exchanger from the inlet (via the opening at face 50) to the outlet (via the opening in face 52), the staggered arrangement of the fins 60 forces the fluid to find a new path between the each row of fins. The staggered arrangement of the conduits acts in similar manner. The chevron shape of the fins is also designed to aggregate mixing of fluid streams through generation of vortices behind leading and trailing edges of the fins. Moreover, the fins 60 of the heat exchanger 10 are formed with a repeating pattern or mesh of diamond shaped holes 69 therethrough, shown in FIG. 6. The holes 69 in the fins 60 increase the surface area of the fins while decreasing the amount of material required to fabricate them. This allows the fins to have reduced weight, and also promotes mixing of fluid streams as the second working fluid passes through the heat exchanger core.

The conduits 45 are also provided with internal structure 80 referred to as ‘turbulators’ (seen best in FIGS. 14 and 15) which are designed to enhance heat transfer between the first working fluid and the fins by preventing laminar flow of the first working fluid in the conduits. The turbulators 80 comprise diamond-shaped partitions within the conduits 45 that are periodically staggered along the length of the conduit that cause the first working fluid to mix as it travels through the heat exchanger core. FIG. 15 shows two lengths of staggered turbulator partitions, absent the external wall of the conduit.

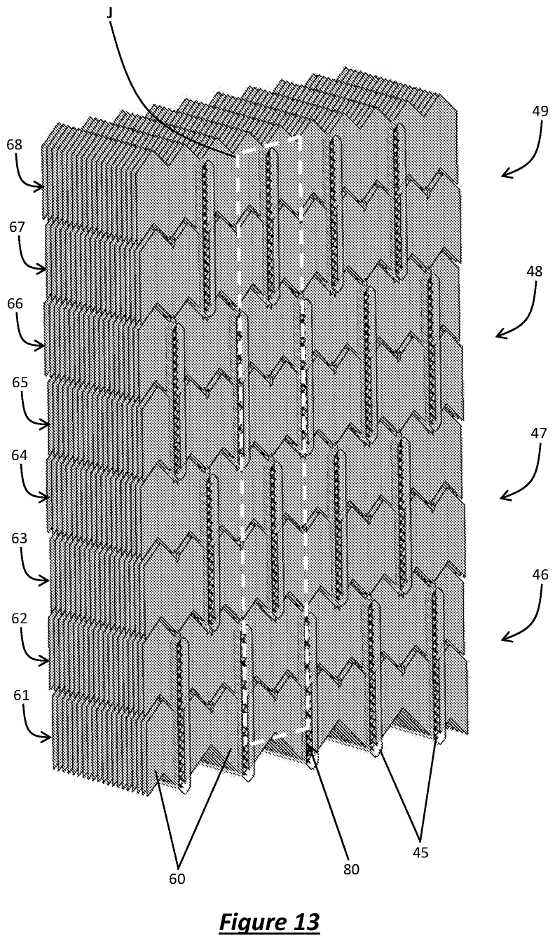

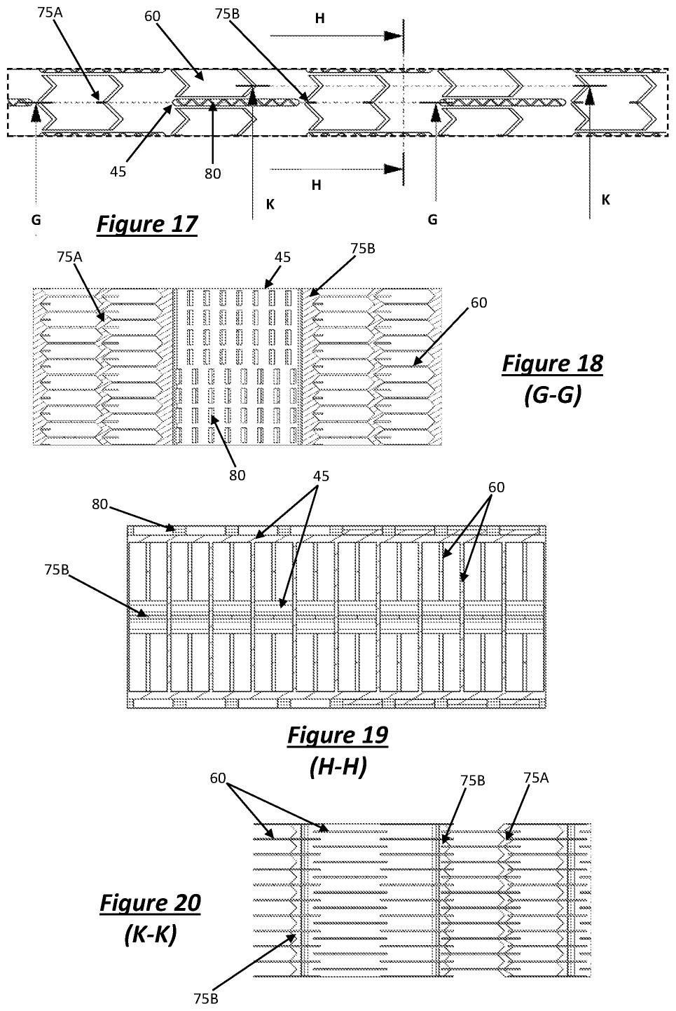

FIG. 17 is a plan view of outlined portion ‘J’ from FIG. 13, and FIGS. 18 to 20 are sectional views through the heat exchanger core as indicated in FIG. 17 at G-G, H-H and K-K, respectively. These figures show details of the internal structure of the heat exchanger core, including the coolant tubes (conduits) 45 with turbulators 80, the air-side fins 60 in staggered arrangement, the fin-support fins 75A and the tube-support fins 75B. Of note, in this embodiment the tube support fins 75B, providing structural support between the air-side fins 60 and the walls of the conduits 45, are enlarged so that they are able to contribute to the heat transfer and improved fluid flow within the heat exchanger core. As well as providing structure, these enlarged micro-fins double as a heat transfer surface in the x-direction, whereas most heat transfer surfaces (e.g. fins 60) extend in the z-direction. The tube support fins 75B effectively act like fins oriented in the x-direction and promote heat transfer from the hottest regions of the coolant tubes (conduits). Being oriented in the flow direction, there is little penalty to pressure drops, unlike the heat transfer surfaces extending in the z-direction which cause local accelerations of flow. These also may help to prevent the formation of fluid wake/separation regions behind the coolant tube, in use.

Although the heat exchanger 10 is constructed such that coolant flows in one direction through the heat exchanger core, it is also possible to provide a manifold at one or both ends of the heat exchanger to redirect coolant from one conduit to another, allowing a multi-pass configuration to be achieved.

Notably, in exemplary embodiments, several features of heat exchanger 10 were previously not possible due to manufacturing restraints. However, the present inventors have advantageously utilized current advances in additive manufacturing techniques to develop exemplary embodiments of heat exchanger 10 generally in accordance with the present disclosure. While the present disclosure is not limited to the use of additive manufacturing to form heat exchanger 10 generally, additive manufacturing does provide a variety of manufacturing advantages, including ease of manufacturing, reduced cost, greater accuracy, etc.

In this regard, utilizing additive manufacturing methods, heat exchanger 10 may be a single piece of continuous metal, and may thus include fewer components and/or joints than known heat exchangers. The integral formation of heat exchanger 10 through additive manufacturing may advantageously improve the overall assembly process. For example, the integral formation reduces the number of separate parts that must be assembled, thus reducing associated time and overall assembly costs. Additionally, existing issues with, for example, leakage, joint quality between separate parts, and overall performance may advantageously be reduced.

Also, the additive manufacturing methods described above enable much more complex and intricate shapes and contours of heat exchanger 10. For example, heat exchanger 10 may include thin walls, narrow passageways, and novel heat exchanging features. All of these features may be relatively complex and intricate for maximizing heat transfer and minimizing the size or footprint of heat exchanger 10. In addition, the additive manufacturing process enables the manufacture of structures having different materials, specific heat transfer coefficients, or desired surface textures, e.g., that enhance or restrict fluid flow through a passageway. The successive, additive nature of the manufacturing process enables the construction of these passages and features. As a result, heat exchanger 10 performance may be improved relative to other heat exchangers.

Suitable additive manufacturing techniques in accordance with the present disclosure include, for example, Laser Powder Bed Fusion (LPBF), Selective Laser Melting (SLM), Direct Metal Laser Melting (DMLM).

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, heat exchanger 10 may be formed in part, in whole, or in some combination of materials including but not limited to pure metals, nickel alloys, chrome alloys, titanium, titanium alloys, magnesium, magnesium alloys, aluminum, aluminum alloys, and austenite alloys such as nickel-chromium-based super-alloys.

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting process. One skilled in the art will appreciate other methods of fusing materials to make a component by additive manufacturing are possible, and the presently disclosed subject matter may be practiced with those methods.

In addition, the additive manufacturing process disclosed herein allows a single component to be formed from multiple materials. Thus, heat exchanger 10 may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although heat exchanger 10 is described above as being constructed entirely by additive manufacturing processes, it should be appreciated that in alternate embodiments, a portion of heat exchanger 10 may be formed via casting, machining, and/or any other suitable manufacturing process. Indeed, any suitable combination of materials and manufacturing methods may be used to form heat exchanger 10.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A crossflow heat exchanger constructed by an additive manufacturing process defining a build direction axis, the heat exchanger having a heat exchanger core with fluid tubes extending in a first direction therethrough for carrying a first working fluid, the heat exchanger core having a plurality of heat exchange fins extending from the fluid tubes, the fins being substantially planar, parallel to one another and transverse to the first direction, wherein spaces between the fins allow for a second working fluid to flow therebetween, in use, in a second direction orthogonal to the first direction.

2. A heat exchanger according to claim 1 wherein substantially all surfaces of the heat exchanger have an angle relative to the build direction axis that allows the heat exchanger to be built upright (vertical orientation).

3. A heat exchanger according to claim 1 wherein substantially all surfaces of the heat exchanger core have a relatively small angle with respect to the build direction axis.

4. A heat exchanger according to claim 3 wherein substantially all of the surfaces of the heat exchanger core have an angle relative to the build direction axis that is less than or equal to a predetermined angle.

5. A heat exchanger according to claim 1 wherein the fluid tubes have a cross section with an elongate dimension parallel to the second direction.

6. A heat exchanger according to claim 1 wherein the fins are narrow and closely spaced having regard to the limitations of the additive manufacturing process.

7. A heat exchanger according to claim 1 wherein the fins have a chevron shape.

8. A heat exchanger according to claim 1 wherein the fluid tubes are arranged in a plurality of rows, with the positions of the fluid tubes in adjacent rows being staggered.

9. A heat exchanger according to claim 8 wherein the fins extend between the fluid tubes within rows.

10. A heat exchanger according to claim 9 wherein each row of the fluid tubes has a plurality of rows of fins.

11. A heat exchanger according to claim 9 wherein the fins extending between the fluid tubes in adjacent rows are staggered with respect to one another in the first direction.

12. A heat exchanger according to claim 11 wherein adjacent rows of fins are staggered with respect to one another in the first direction.

13. A heat exchanger according to claim 9 wherein micro-fins are provided to extend between adjacent rows of fins, the micro-fins being oriented with a planar dimension transverse to the fins.

14. A heat exchanger according to claim 1 wherein the fluid tubes have turbulence-inducing interior structure.

15. A heat exchanger according to claim 1 wherein the fins are formed with a pattern or mesh of apertures therethrough.
